(19) United States
(12) Patent Application Publication
(10) Pub. No.: US 2016/0082485 A1
(43) Pub. Date: Mar. 24, 2016

(54) WASHING POSITION CONFIRMATION DEVICE, FLUID DELIVERY POSITION CONFIRMATION DEVICE, WASHING POSITION CONFIRMATION SYSTEM, AND FLUID DELIVERY POSITION CONFIRMATION METHOD

(71) Applicant: OMRON CORPORATION, Kyoto (JP)

(72) Inventors: Satoshi Shiroko, Nagano (JP); Haruyuki Fujitsuna, Nagano (JP); Akinobu Kakutani, Okayama (JP)

(73) Assignee: OMRON Corporation, Kyoto-shi, Kyoto (JP)

(21) Appl. No.: 14/786,253

(22) PCT Filed: May 8, 2014
(86) PCT No.: PCT/JP2014/062366

§ 371 Date: Oct. 22, 2015

(30) Foreign Application Priority Data
May 20, 2013 (JP) 2013-106310

(51) Int. Cl. B08B 5/02; B08B 13/00

(52) U.S. Cl. CPC B08B 5/02; B08B 13/00

(57) ABSTRACT

A cleaning position checking device, configured to be provided between a fluid supply section and a nozzle having a hole through which a fluid supplied from the fluid supply section is ejected so that a cleaned object is cleaned with the fluid, for checking a position which the fluid to be ejected is to reach, having a joint member having a tubular shape, and having an inlet part through which the fluid flows in the joint member, and an outlet part through which the fluid flows out of the joint member, and a holder having a first opening configured to have a light source disposed therethrough, and a light source section-provided-space formed in the holder configured to hold the light source section therein, so as to allow light to be emitted toward the outlet part.

### BACKGROUND

1. Technical Field

The present invention relates to a cleaning position checking device included in an air-cleaning device for cleaning a cleaning-target object by blowing a fluid to the cleaning-target object.

2. Related Art

Conventionally, there has been known a device which ejects a fluid to an object through a nozzle so as to eliminate dust and the like lying on the object (that is, so as to clean the object). For example, each of Patent Literatures 1 and 2 discloses a technique which facilitates ejection of a fluid to a targeted position. Specifically, Patent Literature 1 discloses a nozzle having a light which nozzle is provided at an end of a flexible tube. The nozzle is configured such that (i) a light source is provided inside the nozzle so that light is emitted through the nozzle and (ii) a fluid is ejected from the flexible tube through the nozzle. This allows a welded surface irradiated by the light source to match a position to which the liquid is ejected through the nozzle. Therefore, by irradiating the welded surface with light, it is possible to accurately eject the fluid to the welded surface. Note that a slit through which the liquid passes is formed in an inner circumferential surface of the nozzle.

Meanwhile, Patent Literature 2 discloses an ejection reaching position checking jig for, before ejection of a substance through a nozzle, checking a position which the substance to be ejected is to reach. The jig is removably attached to the nozzle and has a light emitting material which, in a state where the jig is attached to the nozzle, emits light in a direction identical to that of a trajectory of the substance ejected through the nozzle. This allows a position which light from the light emitting material reaches to match a position which the substance ejected through the nozzle actually reaches. Therefore, before ejecting the substance, it is possible to check the position which the substance to be ejected is to reach, by checking light emitted from the light emitting material.

### CITATION LIST

### Patent Literature

### [Patent Literature 1]

Japanese Patent Application Publication Tokukai No. 2010-23190 (Publication date: Feb. 4, 2010)

### [Patent Literature 2]

Japanese Patent Application Publication Tokukaihei No. 7-132444 (Publication date: May 23, 1995)

### SUMMARY

However, as has been described, the technique of Patent Literature 1 is configured such that (i) the light source is provided inside the nozzle and (ii) the slit is formed in the inner circumferential surface of the nozzle so that a fluid passes therethrough. It is therefore necessary to process the nozzle so as to have such a configuration. Moreover, since a commercially available slit nozzle or a porous nozzle has a flow path whose width is wide, it is not possible to fit a light source into such a nozzle. This causes usable nozzles to be limited. Therefore, the technique of Patent Literature 1 lacks versatility.

Meanwhile, the technique of Patent Literature 2 may not be possible to check, during ejection of the substance, a position which the substance reaches. Furthermore, since a shape of the jig is determined in accordance with a shape of the nozzle, nozzles for which the jig can be used are limited. Therefore, the technique of Patent Literature 2 lacks versatility.

One or more embodiments of the present provides a cleaning position checking device, a fluid reaching position checking device, a cleaning position checking system, and a fluid reaching position checking method, each of which is highly versatile and makes it possible to easily check a position that a fluid to be blown is to reach.

A cleaning position checking device according to one or more embodiments of the present invention is a cleaning position checking device, provided between a fluid supply section and a nozzle having a hole through which a fluid supplied from the fluid supply section is ejected so that an cleaned object is cleaned with the fluid, for checking a position which the fluid to be ejected is to reach, the cleaning position checking device including: a joint member having a tubular shape, the joint member having (i) an inlet part through which the fluid flows in the joint member and (ii) an outlet part through which the fluid flows out of the joint member; and a holder having (a) a first opening through which a light source section is provided and (b) a light source section provided space therein in which the light source section is held so as to emit light toward the outlet part.

One or more embodiments of the present invention is highly versatile and which makes it possible to easily check a position that a fluid to be blown is to reach.

### BRIEF DESCRIPTION OF DRAWINGS

FIG. 1 is a view illustrating an example air-cleaning device in accordance with an embodiment of the present invention.

FIG. 2 is a perspective view illustrating an inside of a joint.

FIG. 3 is an enlarged view illustrating the inside of the joint.

FIG. 4 is a view illustrating example control carried out with respect to a light source.

FIG. 5 is a first view illustrating an example light source in accordance with a variation of the present invention.

FIG. 6 is a second view illustrating an example light source in accordance with a variation of the present invention.

FIG. 7 is a view illustrating an example nozzle.

FIG. 8 is a view illustrating an example nozzle in accordance with a variation of the present invention.

FIG. 9 is a first view illustrating an example joint in accordance with a variation of the present invention.

FIG. 10 is a second view illustrating an example joint in accordance with a variation of the present invention.

FIG. 11 is a third view illustrating an example joint in accordance with a variation of the present invention.

FIG. 12 is a fourth view illustrating an example joint in accordance with a variation of the present invention.

### DETAILED DESCRIPTION

Embodiments of the present invention will be described below with reference to the drawings. In the following description, identical reference signs are given to respective identical components. The identical components have respective identical names and functions. Therefore, such identical components will not be repeatedly described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

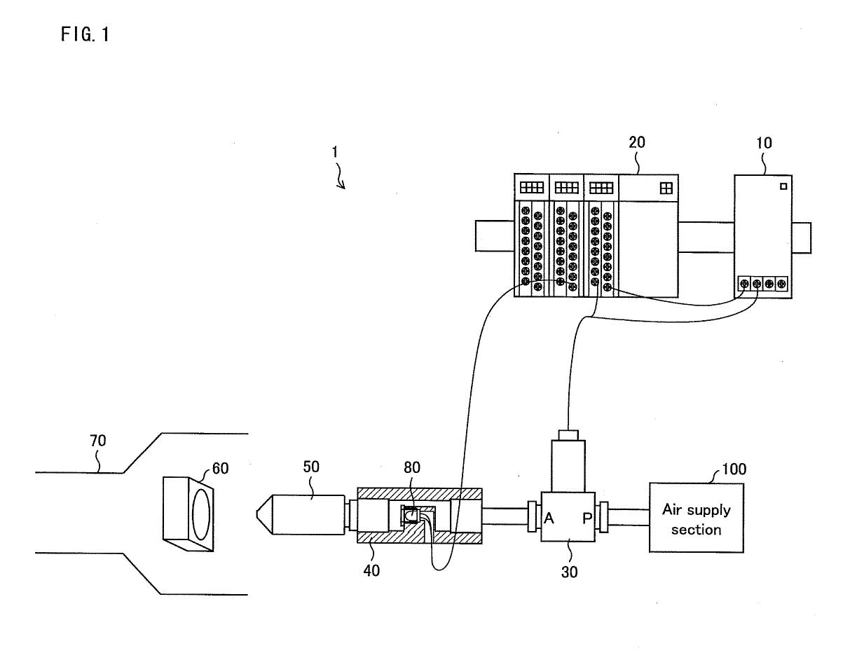

FIG. 1 is a view illustrating an example air-cleaning device in accordance with an embodiment of the present invention. The air-cleaning device is a device which blows air to a cleaning-target object (cleaned object), which is retained at a predetermined height by a support, so as to eliminate dust and the like from the cleaning-target object.

Specifically, as illustrated in FIG. 1, an air-cleaning device (cleaning position checking system) 1 includes an air supply section (fluid supply section) 100 which supplies pressurized air, an electromagnetic valve 30, a joint 40, a nozzle 50, a power source 10, a control device 20, and a dust collecting duct 70. Air outputted from the air supply section 100 passes through the electromagnetic valve 30 and the joint 40 in this order, and reaches the nozzle 50. The air is then blown to a cleaning-target object 60 through the nozzle 50. Dust eliminated from the cleaning-target object 60 by blowing air to the cleaning-target object 60 is collected by a dust collector (not illustrated) through the dust collecting duct 70. Note that the air supply section 100 can further include a regulator for regulating a pressure of air to a predetermined pressure, a filter for eliminating a mist from air, and the like.

Note that one or more embodiments of the present invention will take, as an example, a case where air is blown to a cleaning-target object. However, the present embodiment is not limited to air, and any fluid including gas, such as nitrogen and argon, and liquids, such as water, can be alternatively employed.

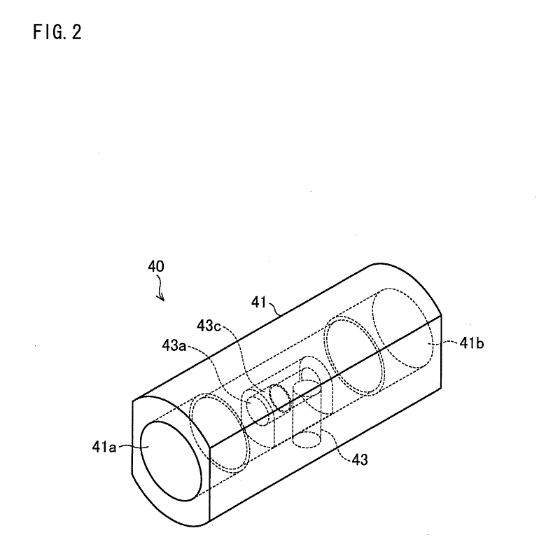

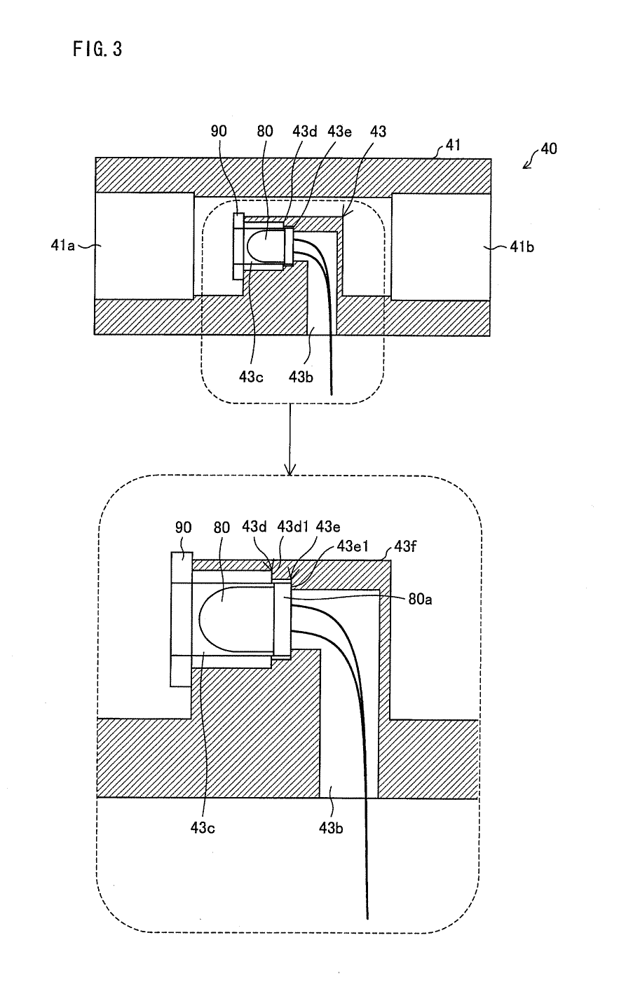

The control device 20 is connected to the electromagnetic valve 30 and a light source 80 which is provided inside the joint (cleaning position checking device) 40 provided between the nozzle 50 and the electromagnetic valve 30. The control device 20 controls (i) opening and closing of the electromagnetic valve 30 and (ii) the light source 80. The power source 10 supplies electric power to the control device 20, the electromagnetic valve 30, and the light source 80. Here, the joint 40 will be described in detail with reference to FIGS. 2 and 3.

FIG. 2 is a perspective view illustrating an inside of a joint. FIG. 3 is an enlarged view illustrating the inside of the joint. As illustrated in FIGS. 2 and 3, the joint 40 includes (i) a joint member 41 having a substantially cylindrical shape (tubular shape) and (ii) a holder 43 formed inside the joint member 41. The joint member 41 has (a) an inlet part 41b through which a fluid flows in the joint member 41 and (b) an outlet part 41a through which the fluid flows out of the joint member 41.

The joint member 41 is configured such that (i) the inlet part 41b is connected to a side of the electromagnetic valve 30 through which side air is discharged and (ii) the outlet part 41a is connected to the nozzle 50. Specifically, a thread groove is formed in an area of an inner circumferential surface of the joint member 41 which area extends, by a predetermined length, from the inlet part 41b. A tube which the electromagnetic valve 30 has and whose outer circumferential surface has therein a thread groove (outlet part of the electromagnetic valve 30) is screwed into the inlet part 41b. Similarly, a thread groove is formed in an area of the inner circumferential surface of the joint member 41 which area extends, by a predetermined length, from the outlet part 41a. A tube which the nozzle 50 has and whose outer circumferential surface has therein a thread groove (inlet part of the nozzle 50) is screwed into the outlet part 41a.

The holder 43 is fixed to the inner circumferential surface of the joint member 41. The holder 43 includes (i) a member (cylindrical member) 43f which has a cylindrical shape and which has an opening (first opening) 43a that faces the outlet part 41a of the joint member 41 and (ii) a cap 90 which covers the opening 43a. An outer diameter of the cylindrical member 43f is smaller than an inner diameter of the joint member 41. This allows, between the joint member 41 and the holder 43, air which has flowed in the joint member 41 through the inlet part 41b to flow toward the outlet part 41a. Note that the shape of the cylindrical member 43f is not limited to the cylindrical shape and can alternatively have any shape.

The cylindrical member 43f has a light source section provided space 43c in which the light source 80 is held. Specifically, the cylindrical member 43f successively has a first step part 43d and a second step part 43e on its inner circumferential surface on an inner side of the opening 43a. The first and second step parts 43d and 43e cause an inner diameter of the cylindrical member 43f to be smaller in part. The first step part 43d, which is closer to the opening 43a than the second step part 43e, has a first contact surface 43d1 which extends in a radial direction.

An edge of the cap 90, which covers the opening 43a of the cylindrical member 43f and which causes the light source 80 to be contained in the light source section provided space 43c, is in contact with the first contact surface 43d1. The second step part 43e, which is further from the opening 43a that the first step part 43d, has a second contact surface 43e1 which extends in the radial direction. In a case where the light source 80 is inserted into the cylindrical member 43f through the opening 43a from a flange part 80a of the light source 80, a back surface of the flange part 80a is in contact with the second contact surface 43e1.

An inner diameter of the cap 90 is slightly smaller than an outer diameter of the flange part 80a of the light source 80, and is large enough to cover a light emitting part, other than the flange part 80a, of the light source 80. A distance between the first contact surface 43d1 and the second contact surface 43e1 is substantially equal to a thickness of the flange part 80a of the light source 80. Therefore, in a case where (i) the light source 80 is inserted into the cylindrical member 43f and (ii) the cap 90 is fitted to the opening 43a, the back surface of the flange part 80a of the light source 80 is supported by the second contact surface 43e1, and a front surface of the flange part 80a is supported by the edge of the cap 90. This allows the light source 80 to be positioned. A light axis of the light source 80 corresponds to a direction of a fluid flowing from the inlet part 41b to the outlet part 41a.

Note that the cap 90 can be arranged so as to have a high light-transmitting property by applying a solvent or the like on an outer surface of the cap 90. Further, the cap 90 can be processed into a lens shape so as to collect light emitted from the light source 80. A gap between the cap 90 and the cylindrical member 43f is sealed by a sealing member or a packing so as to prevent leakage of air. This also prevents external air from entering the joint member 41.

The joint 40 has a through-hole (second opening) 43b. The through-hole 43b is located on an end of the space, in which the light source 80 is provided, of the cylindrical member 43f which end is different from an end at which the opening 43a is provided, and extends from an inside of the cylindrical member 43f to an outside of the joint member 41. The light source 80 is connected to the control device 20 and the power source 10 through the through-hole 43b.

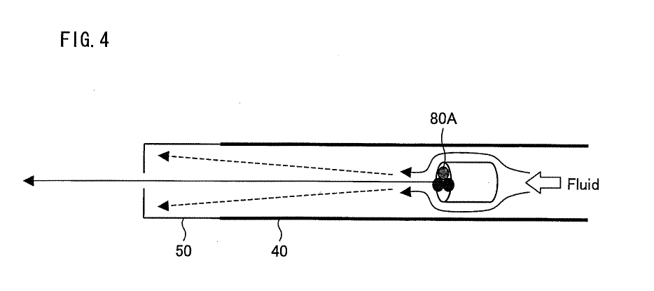

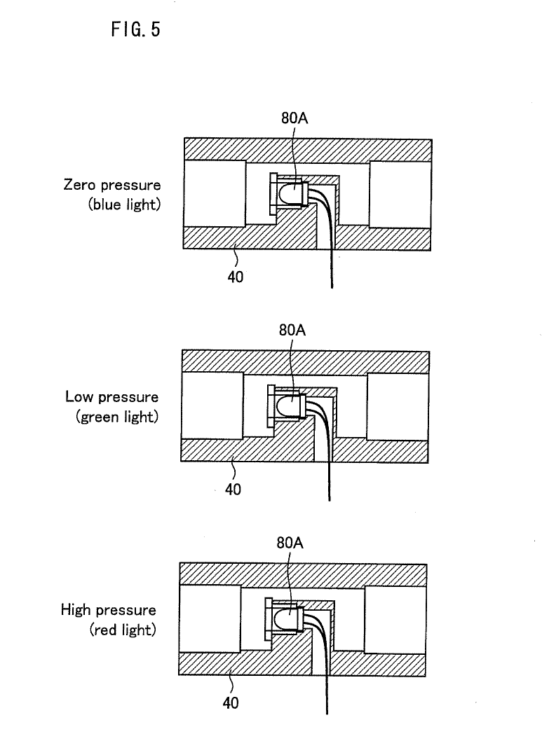

The light source 80 only needs to be one, such as an LED and a laser, that emits light traveling straight. The LED is not limited to a monochromatic LED, and can be alternatively a full-color LED or a color LED. For example, as illustrated in FIG. 4, a light source 80A which is a full-color LED having a plurality of LED chips that emit light of respective different colors can be provided inside the holder 43. In this case, a pressure sensor or the like is provided inside the nozzle 50, and the control device 20 controls the light source 80A to change colors depending on a change in pressure in the nozzle 50. For example, as illustrated in FIG. 5, in a case where a value of the pressure is 0 (zero), the control device 20 controls the light source 80A to emit blue light. In a case where the value of the pressure is low, the control device 20 controls the light source 80A to emit green light. In a case where the value of the pressure is high, the control device 20 controls the light source 80A to emit red light.

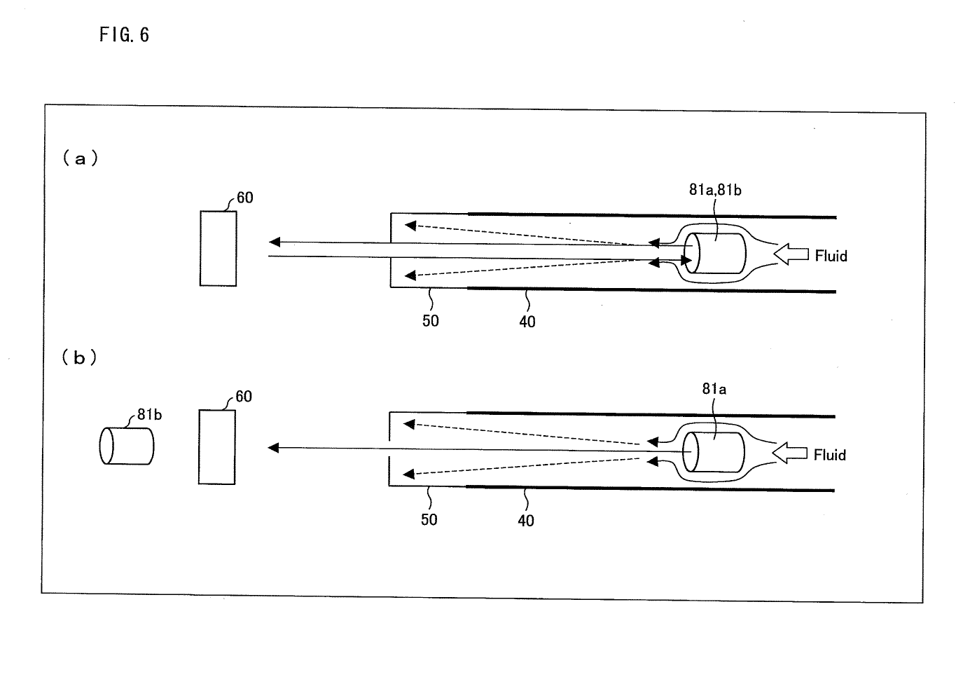

Alternatively, as illustrated in FIG. 6, a photoelectric sensor which detects an object with use of light can be employed instead of the light source 80. The photoelectric sensor includes (i) a light emitting section (light source section) 81a which emits light and (ii) a light receiving section 81b which receives light. In this case, the control device 20 controls (i) the photoelectric sensor to detect the cleaning-target object 60 depending on whether or not the receiving section 81b detects light from the light emitting section 81a and (ii) air to be blown to the cleaning-target object 60. Specifically, in a case where the cleaning-target object 60 is detected, the control device 20 controls the electromagnetic valve 30 to be open so that air is blown to the cleaning-target object 60. That is, air is supplied from the air supply section 100 to nozzle 50. In a case where the cleaning-target object 60 ceases to be detected, the control device 20 controls the electromagnetic valve 30 to be closed so that a blow of the air is stopped. That is, supply of the air from the air supply section 100 to the nozzle 50 is stopped.

Note that the photoelectric sensor can be configured such that the light emitting section 81a and the light receiving section 81b are integrated with each other as illustrated in (a) of FIG. 6. Alternatively, the photoelectric sensor can be configured such that the light emitting section 81a and light receiving section 81b are separated from each other as illustrated in (b) of FIG. 6. That is, according to an example illustrated in (a) of FIG. 6, the light emitting section 81a and the light receiving section 81b are provided in the light source section provided space 43c. According to an example illustrated in (b) of FIG. 6, the light emitting section 81a is provided in the light source section provided space 43c, and the light receiving section 81b is provided at a position which is located outside the joint 40 and which is located on a path along which light from the light source 80 travels. In a case of (a) of FIG. 6, the control device 20 controls the photoelectric sensor to detect the cleaning-target object 60 in a case where light from the light emitting section 81a is reflected by the cleaning-target object 60 and received by the light receiving section 81b. Note that, in the case of (a) of FIG. 6, the light receiving section 81b is arranged so as not to receive light directly from the light emitting section 81a. For example, a shielding plate is provided between the light emitting section 81a and the light receiving section 81b. In a case of (b) of FIG. 6, the control device 20 controls the photoelectric sensor to detect the cleaning-target object 60 in a case where light from the light emitting section 81a is not received by the light receiving section 81b.

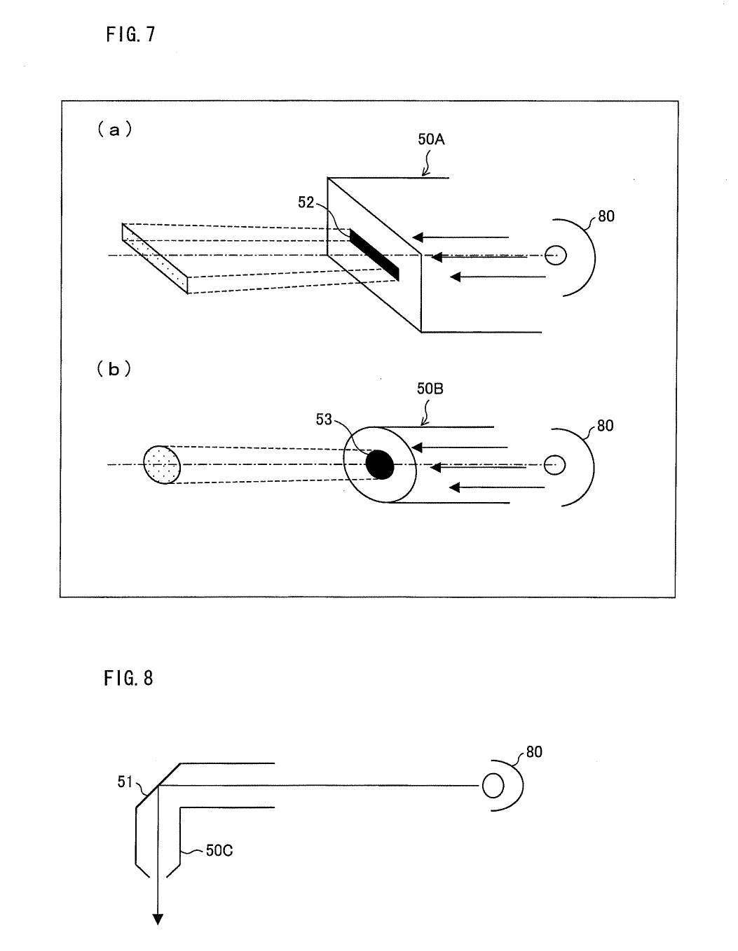

The nozzle 50 has a shape of a cylinder whose end is tapered, that is, a diameter of the nozzle 50 becomes smaller toward an end of the nozzle 50. A slit (hole) is formed in the end of the nozzle 50. Air is discharged through the slit of the nozzle 50. FIG. 7 is a view illustrating an example nozzle. As illustrated in (a) of FIG. 7, a nozzle 50A has a slit 52 having a rectangular shape. In a case where light from the light source 80 passes through the slit 52, light having a shape identical to that of the slit 52 is emitted. On the other hand, as illustrated in (b) of FIG. 7, a nozzle 50B has a slit 53 having a substantially circular shape. In a case where light from the light source 80 passes through the slit 53, light having a shape identical to that of the slit 53 is emitted. Therefore, it is possible to visually check, by checking an irradiation pattern, an area to which air is to be blown.

Note that the shape of the nozzle only needs to be one that allows light from the light source 80 to reach the cleaning-target object 60. Note also that a flow path, such as an inside of the nozzle or the inside of the joint, can be processed with mirror finish so as to be reflective. Alternatively, a reflective material can be used so that the flow path is reflective. Moreover, the shape of the nozzle is not limited to a cylindrical shape. For example, a nozzle 50C can be employed which has such a shape that a cylinder is bent in the middle thereof as illustrated in FIG. 8. In this case, a reflective plate 51 is provided at such a bent part of the cylinder so as to reflect light from the light source 80 toward a slit.

As has been described, a joint 40 according to one or more embodiments of the present invention is a device, provided between an air supply section 100 and a nozzle 50 having a hole through which air supplied from the air supply section 100 is ejected so that a cleaning-target object 60 is cleaned with the air, for checking a position which the air to be ejected is to reach, the joint 40 including: a joint member 41 having a tubular shape, the joint member 41 having (i) an inlet part 41b through which the air flows in the joint member 41 and (ii) an outlet part 41a through which the air flows out of the joint member 41; and the holder having (a) an opening 43a through which a light source 80 is inserted into the holder and (b) a light source section provided space 43c in which the light source 80 is held so as to emit light toward the outlet part 41a.

According to the above configuration, in a case where the light source 80 is provided in the light source section provided space 43c, it is possible to cause light to travel in a direction in which air flows. This allows a user to visually check a position which air is to reach. Furthermore, since the light source is not provided to the nozzle unlike the conventional techniques, it is not necessary to process the nozzle, depending on a type of the nozzle, so that the light source can be provided to the nozzle. This allows the joint to be used in connection with various types of nozzles. It is therefore possible to easily check a position which air to be blown is to reach, and possible to improve versatility.

In a case where the air-cleaning device 1 is provided to an automated machine which blows air to sequentially conveyed cleaning-target objects 60, it is possible to shorten a time to position the nozzle 50 and possible to simplify management of the nozzles 50, because a position which air is to reach is easily checked. Moreover, it is only necessary to adjust the nozzle 50 so that target positions on the cleaning-target objects 60 are irradiated with light. Further, it can be seen that the nozzle 50 is not displaced even during production. Therefore, no special technique is needed to conduct checking operation.

Conventionally, in a case where a worker manually cleans a cleaning-target object 60, the worker visually checks a position of a nozzle, locates a position to which air is blown through the nozzle, and moves the cleaning-target object 60 by his/her hand so as to clean the cleaning-target object 60. In contrast, according to the air-cleaning device 1 according to one or more embodiments of the present invention, it is possible to absolutely and quantitatively give an highly effective clean (that is, it is possible to blow air a predetermined time later the cleaning-target object 60 is irradiated with light) merely by bringing, without regard to the nozzle 50, the cleaning-target object 60 to a position which light reaches.

Note that the air-cleaning device 1 according to one or more embodiments of the present invention can be configured so as to clean the cleaning-target object 60 by removing static electricity from the cleaning-target object 60. Specifically, a fluid reaching position checking device (ionizer) is configured by providing an ion generating device to the inlet part 41b of the joint 40. With this, an ionized fluid (air) is ejected through the nozzle 50, so that static electricity is removed from the cleaned object. It is thus possible to prevent powder dust and the like from attaching to the cleaned object.

<Variations>

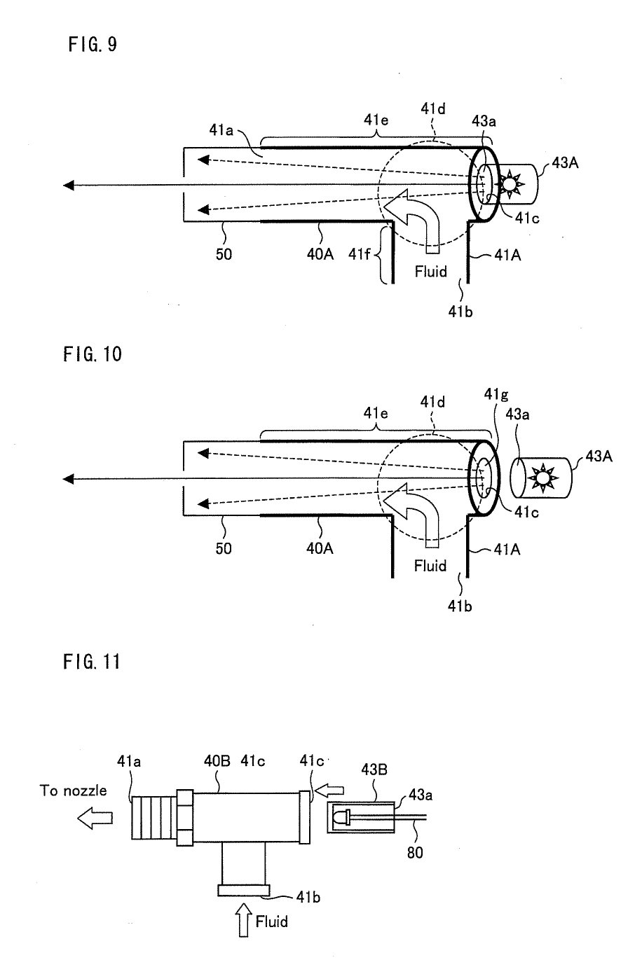

The air-cleaning device 1 according to one or more embodiments of the present is configured such that the light source 80 is provided inside the joint 40 having a linear shape. An air-cleaning device 1 of a variation is configured such that a light source 80 is provided to a bent joint. FIG. 9 is a view illustrating an example joint of a variation. As illustrated in FIG. 9, a joint 40A has a joint member 41A which has a cylindrical shape and which is bent into an L shape. That is, the joint member 41A has a bent part 41d, a tube part 41e which linearly extends from the bent part 41d to an outlet part 41a, and a tube part 41f which linearly extends from the bend part 41d to an inlet part 41b. A nozzle 50 is connected to the outlet part 41a of the joint member 41A, and an electromagnetic valve 30 is connected to the inlet part 41b of the joint member 41A. The joint member 41A further has an opening (third opening) 41c which is provided along a direction of a flow path formed by the tube part 41e and which faces the outlet part 41a. A holder 43A is fitted and fixed to the opening 41c. The holder 43A and the joint 40A can be fixed to each other by screwing up overlapping parts of the holder 43A and of the joint 40A. Alternatively, the holder 43A and the joint 40A can be fixed to each other in such a manner that an outer circumferential surface of the holder 43A is supported by an annular rubber provided along an inner side of the opening of the joint 40A. Note that the holder 43A is one that is obtained by increasing a size of the holder 43 illustrated in FIG. 2 in accordance with the opening of the joint. Note also that the shape of the joint is not limited to an L shape, and can be alternatively a T shape.

Note that the air-cleaning device 1 is not limited to such a configuration that the holder 43A and the joint 40A are fixed to each other. Alternatively, the air-cleaning device 1 can be configured such that the holder 43A is fixed at a position apart from the joint 40A in a state where an opening 43a of the holder 43A is aligned with the opening 41c of the joint 40A as illustrated in FIG. 10. In this case, the opening 41c of the joint 40A is covered by a transparent part 41g which transmits light from an outside of the joint 40A to an inside of the joint 40A.

Note that a commercially available joint can be used in combination with the holder. For example, as illustrated in FIG. 11, a commercially available joint 40B having a T shape can be used in such a manner that (i) an outlet part 41a located at a left end of the joint 40B is connected to the nozzle 50, (ii) an inlet part 41b located at a lower end of the joint 40B is connected to the electromagnetic valve 30, and (iii) an opening (third opening) 41c located at a right end of the joint 40B is connected to a holder 43B. The holder 43B is a member having a cylindrical shape, and has an opening 43a at its one end. The other end or the whole of the holder 43B has a light-transmitting property. The holder 43B is fitted to the opening 41c of the joint 40B in such a manner that the opening 43a of the holder 43B is located backward in a direction in which the holder 43B is inserted into the opening 41c of the joint 40B. This causes the opening 41c to be covered. In other words, the holder 43B serves as a stopper of the opening 41c of the joint 40B. The light source 80 is inserted into the holder 43B through the opening 43a of the holder 43B in such a manner that a light emitting section is located forward in a direction in which the light source 80 is inserted into the holder 43B.

Note that the light source is used to check a position to which a fluid is to be blown through a slit. Alternatively, a member which outputs an ultrasonic wave (ultrasonic wave generating section) and a member which visualizes the ultrasonic wave can be used.

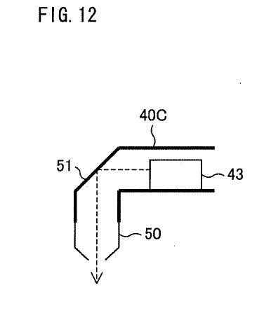

Note also that, as illustrated in FIG. 12, a joint 40C can be alternatively employed which is configured so as to have a bent part between a holder 43 and an outlet part 41a and to have a reflective plate 51 at the bent part. The reflective plate 51 allows light from the light source 80 to be guided to the slit of the nozzle 50.

Note that the fluid of the present invention is not limited to gas or a liquid in terms of making it possible to check a position which the fluid is to reach. However, in a case where an invisible fluid such as air or ionized air is particularly used, it is possible to achieve an effect that a position which the fluid is to reach is visualized. Note also that the term “clean” is not limited to cleaning an object with a fluid. As with the aforementioned case where ionized air is used, the term “clean” encompasses a case where powder dust and the like are prevented from attaching to an object by removing static electricity from the object with use of an ion.

A cleaning position checking device according to one or more embodiments of the present invention is a cleaning position checking device, provided between a fluid supply section and a nozzle having a hole through which a fluid supplied from the fluid supply section is ejected so that an cleaned object is cleaned with the fluid, for checking a position which the fluid to be ejected is to reach, the cleaning position checking device including: a joint member having a tubular shape, the joint member having (i) an inlet part through which the fluid flows in the joint member and (ii) an outlet part through which the fluid flows out of the joint member; and a holder having (a) a first opening through which a light source section is provided and (b) a light source section provided space therein in which the light source section is held so as to emit light toward the outlet part.

According to the above configuration, in a case where the light source section is provided in the light source section provided space, it is possible to cause light to propagate in a direction in which the fluid flows. This allows a user to visually check a position which the fluid is to reach. Furthermore, since the light source section is not provided to the nozzle unlike the conventional techniques, it is not necessary to process the nozzle, depending on a type of the nozzle, so that the light source section can be provided to the nozzle. This allows various types of nozzles to be connected to the cleaning position checking device. It is therefore possible to easily check a position which the fluid to be blown is to reach, and possible to provide a highly versatile cleaning position checking device.

The cleaning position checking device according to one or more embodiments of the present invention can be arranged such that the holder is provided inside the joint member.

Further, the cleaning position checking device according to one or more embodiments of the present invention can be arranged such that: the first opening faces the outlet part; and the holder includes a cap which is fitted to the first opening and which is made of a light-transmitting material.

According to the above configuration, it is possible to easily cause light to reach a cleaning-target object.

Furthermore, since the first opening is covered by the cap, no external foreign substance enters the fluid through the first opening.

Further, the cleaning position checking device according to one or more embodiments of the present invention can be arranged such that the holder and the joint member have a second opening via which the light source section provided space is connected to an outside of the cleaning position checking device.

According to the above configuration, it is possible to connect the light source section to a power source through the second opening.

Further, the cleaning position checking device according to one or more embodiments of the present invention can be arranged such that: the joint member has (i) a bent part and (ii) a tube part which linearly extends from the bent part to the outlet part; and the joint member has, in addition to the inlet part and the outlet part, a third opening which is provided along a direction of a flow path formed by the tube part and which faces the outlet part; and the holder is fitted and fixed to the third opening.

Further, the cleaning position checking device according to one or more embodiments of the present invention can be arranged such that: the joint member has (i) a bent part and (ii) a tube part which linearly extends from the bent part to the outlet part; the bent part has, in a portion which is provided along a direction of a flow path formed by the tube part and which faces the outlet part, a transparent part which transmits light from an outside of the joint member to an inside of the joint member; and the holder is provided, in a state where the holder is apart from the joint member, so that the light from the light source section enters the joint member through the transparent part.

Further, the cleaning position checking device according to one or more embodiments of the present invention can be arranged such that the joint member includes a reflective plate which guides, to the outlet part, the light emitted from the light source section.

According to the above configuration, it is possible to easily check, with such a simple configuration, a position which the fluid to be blown is to reach.

The cleaning position checking device according to one or more embodiments of the present invention is arranged such that a light axis of the light source section corresponds to an axis along which the fluid is ejected.

A cleaning position checking system according to one or more embodiments of the present invention includes: the cleaning position checking device; a light source section provided in the light source section provided space; and a control section which controls the light source section to emit light depending on a pressure in the nozzle.

According to the above configuration, it is possible to easily check a position which a fluid to be blown is to reach, and possible to provide a highly versatile cleaning position checking device. Moreover, it is possible to check strength with which the fluid is blown, by turning on or off the light source section.

The cleaning position checking system according to one or more embodiments of the present invention is arranged such that: the light source section emits light of a plurality of different colors; and the control section controls the light source section to change colors of the light depending on the pressure in the nozzle.

According to the above configuration, it is possible to check strength with which the fluid is blown, by checking a color of light.

A cleaning position checking system according to one or more embodiments of the present invention includes: the cleaning position checking device; a light source section provided in the light source section provided space; a light receiving section provided in the light source section provided space, the light receiving section receiving light that enters the light source section provided space through the outlet part; and a control section which controls (i) detection of the cleaned object depending on whether the light receiving section receives the light, (ii) the fluid to be supplied from the fluid supply section to the nozzle in a case where the cleaned object is detected, and (iii) supply of the fluid from the fluid supply section to the nozzle to be stopped in a case where the cleaned object is not detected.

A cleaning position checking system according to one or more embodiments of the present invention includes: the cleaning position checking device; a light source section provided in the light source section provided space; a light receiving section provided at a position which is located outside the cleaning position checking device and which is located on a path along which light from the light source section travels; and a control section which controls (i) detection of the cleaned object depending on whether the light receiving section receives the light, (ii) the fluid to be supplied from the fluid supply section to the nozzle in a case where the cleaned object is detected, and (iii) supply of the fluid from the fluid supply section to the nozzle to be stopped in a case where the cleaned object is not detected.

According to the above configuration, it is possible to automatically blow the fluid.

A fluid reaching position checking device according to one or more embodiments of the present invention is a fluid reaching position checking device, provided between a fluid supply section and a nozzle having a hole through which a fluid supplied from the fluid supply section is ejected, for checking a position which the fluid to be ejected is to reach, the fluid reaching position checking device including: a joint member having a tubular shape, the joint member having (i) an inlet part through which the fluid flows in the joint member and (ii) an outlet part through which the fluid flows out of the joint member; and a holder having (a) a first opening through which a light source section is provided and (b) a light source section provided space therein in which the light source section is held so as to emit light toward the outlet part.

According to the above configuration, it is possible to easily check a position the fluid to be blown is to reach, and possible to provide a highly versatile fluid reaching position checking.

The fluid reaching position checking device according to one or more embodiments of the present invention is arranged such that the fluid ejected through the nozzle is gas or ionized gas.

The fluid reaching position checking device and the cleaning position checking device according to one or more embodiments of the present invention are each arranged such that a light axis of the light source section corresponds to an axis along which the fluid is ejected.

A fluid reaching position checking method according to one or more embodiments of the present invention is a fluid reaching position checking method using a fluid reaching position checking device, provided between a fluid supply section and a nozzle having a hole through which a fluid supplied from the fluid supply section is ejected, for checking a position which the fluid is to reach, the fluid reaching position checking device including: a joint member having a tubular shape, the joint member having (i) an inlet part through which the fluid flows in the joint member and (ii) an outlet part through which the fluid flows out of the joint member; and a holder having (a) a first opening through which a light source section is provided and (b) a light source section provided space therein in which the light source section is held so as to emit light toward the outlet part.

According to the above configuration, it is possible to easily check a position which the fluid to be blown is to reach, and possible to provide a highly versatile fluid reaching position checking method.

The present invention is not limited to the above embodiments, but can be altered by a skilled person in the art within the scope of the claims. An embodiment derived from a proper combination of technical means each disclosed in a different embodiment is also encompassed in the technical scope of the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

1 Air-cleaning device (cleaning position checking system)
20 Control device
30 Electromagnetic valve
40, 40A, 40B, 40C Joint (cleaning position checking device)
41, 41A Joint member
41a Outlet part
41b Inlet part
41c Opening (third opening)
41d Bent part
41e Tube part
41g Transparent part
43, 43A, 43B Holder
43a Opening (first opening)
43b Through-hole (second opening)
43c Light source section provided space
43f Cylindrical member
50, 50A, 50B, 50B Nozzle
51 Reflective plate Cleaning-target object (cleaned object)
80, 80A Light source (light source section) Cap
100 Air supply section (fluid supply section)

1. A cleaning position checking device, configured to be provided between a fluid supply section and a nozzle having a hole through which a fluid supplied from the fluid supply section is ejected so that a cleaned object is cleaned with the fluid, for checking a position which the fluid to be ejected is to reach, the cleaning position checking device comprising:
a joint member having a tubular shape, and comprising:
an inlet part through which the fluid flows in the joint member, and
an outlet part through which the fluid flows out of the joint member; and
a holder comprising:
a first opening configured to have a light source disposed therethrough, and
a light source section-provided-space formed in the holder configured to hold the light source section therein, so as to allow light to be emitted toward the outlet part.

2. The cleaning position checking device as set forth in claim 1, wherein the holder is provided inside the joint member.

3. The cleaning position checking device as set forth in claim 2,
wherein the first opening faces the outlet part, and
wherein the holder comprises a cap fitted to the first opening and made of a light-transmitting material.

4. The cleaning position checking device as set forth in claim 2, wherein the holder and the joint member comprise a second opening via which the light source section-provided-space is connected to an outside of the cleaning position checking device.

5. The cleaning position checking device as set forth in claim 1,
wherein the joint member further comprises:
a bent part,
a tube part that linearly extends from the bent part to the outlet part, and
a third opening provided along a direction of a flow path formed by the tube part and which faces the outlet part, and
wherein the holder is fitted and fixed to the third opening.

6. The cleaning position checking device as set forth in claim 1,
wherein the joint member comprises:
a bent part, and
a tube part that linearly extends from the bent part to the outlet part;
wherein the bent part comprises, in a portion which is provided along a direction of a flow path formed by the tube part and which faces the outlet part, a transparent part that transmits light from an outside of the joint member to an inside of the joint member; and
wherein the holder is disposed apart from the joint member, so as to allow the light from the light source section to enter the joint member through the transparent part.

7. The cleaning position checking device as set forth in claim 1, wherein the joint member comprises a reflective plate that is configured to guides the light emitted from the light source section to the outlet part.

8. The cleaning position checking device as set forth in claim 1, wherein the cleaning position checking device is configured such that a light axis of the light source section corresponds to an axis along which the fluid is ejected.

9. A cleaning position checking system comprising:
the cleaning position checking device as set forth in claim 1;
the light source section provided disposed in the light source section-provided-space; and
a control section that controls the light source section to emit light depending on a pressure in the nozzle.

10. The cleaning position checking system as set forth in claim 9,
wherein the light source section emits light of a plurality of different colors; and
wherein the control section controls the light source section to change colors of the light depending on the pressure in the nozzle.

11. A cleaning position checking system comprising:
the cleaning position checking device as set forth in claim 1;
the light source section disposed in the light source section-provided-space;
a light receiving section disposed in the light source section-provided-space, the light receiving section receiving light that enters the light source-provided-space through the outlet part; and
a control section that controls:
detection of the cleaned object depending on whether the light receiving section receives the light,
the fluid to be supplied from the fluid supply section to the nozzle in a case where the cleaned object is detected, and
supply of the fluid from the fluid supply section to the nozzle to be stopped in a case where the cleaned object is not detected.

12. A cleaning position checking system comprising:
the cleaning position checking device as set forth in claim 1;
a light source section provided in the light source-provided-space;
a light receiving section disposed at a position which is located outside the cleaning position checking device, and which is located on a path along which light from the light source section travels; and
a control section that controls
detection of the cleaned object depending on whether the light receiving section receives the light,
the fluid to be supplied from the fluid supply section to the nozzle in a case where the cleaned object is detected, and
supply of the fluid from the fluid supply section to the nozzle to be stopped in a case where the cleaned object is not detected.

13. A fluid reaching position checking device, configured to be provided between a fluid supply section and a nozzle having a hole through which a fluid supplied from the fluid supply section is ejected, for checking a position which the fluid to be ejected is to reach, the fluid reaching position checking device comprising:
a joint member having a tubular shape, and comprising:
an inlet part through which the fluid flows in the joint member, and
an outlet part through which the fluid flows out of the joint member; and
a holder comprising:
a first opening configured to have a light source disposed therethrough, and
a light source section-provided-space formed in the holder configured to hold the light source section therein, so as to allow light to be emitted toward the outlet part.

14. The fluid reaching position checking device as set forth in claim 13, wherein the fluid ejected through the nozzle is gas or ionized gas.

15. The fluid reaching position checking device as set forth in claim 13, wherein the fluid reaching position checking device is configured such that a light axis of the light source section corresponds to an axis along which the fluid is ejected.

16. A fluid reaching position checking method comprising:
disposing a fluid reaching position checking device between a fluid supply section and a nozzle having a hole through which a fluid supplied from the fluid supply section is ejected; and
checking a position which the fluid is to reach,
wherein the fluid reaching position checking device comprises:
a joint member having a tubular shape, and comprising:
an inlet part through which the fluid flows in the joint member, and
an outlet part through which the fluid flows out of the joint member, and
a holder comprising:
a first opening configured to have a light source section disposed therethrough, and
a light source section-provided-space formed in the holder configured to hold the light source section therein, so as to allow light to be emitted toward the outlet part.
